(19) United States
(12) Patent Application Publication
(10) Pub. No.: US 2021/0163846 A1
(43) Pub. Date: Jun. 3, 2021

(54) METHOD AND EQUIPMENT FOR GREASE PURIFICATION

(71) Applicant: Beihang University, Beijing (CN)

(72) Inventors: Ziyu Liu, Beijing (CN); Xiaoyi Yang, Beijing (CN)

(21) Appl. No.: 15/780,174

(22) PCT Filed: Dec. 13, 2017
(86) PCT No.: PCT/CN2017/115816

§ 371 Date: May 30, 2018

(30) Foreign Application Priority Data
Sep. 25, 2017 (CN) 201710872768.1

(51) Int. Cl. C11C 1/04; F24S 10/30; F24S 20/20

(52) U.S. Cl. CPC C11C 1/04; F24S 20/20; F24S 10/30

(57) ABSTRACT

A method for grease purification is disclosed. The method comprises steps of: S1, feeding crude grease into a grease hydrolysis column to be hydrolysed so as to obtain aqueous phase, organic phase, and middle layer substances between the aqueous phase and the organic phase; S2, feeding the organic phase and the middle layer substances in the grease hydrolysis column into a flash stripping column to be flashed so as to obtain vaporized products and non-vaporized products; and S3, feeding the vaporized products in the flash stripping column into a separation column to be separated so as to obtain fatty acid. By this method, fatty acid with a high purity can be obtained; glycerin can be obtained as a co-product; and high value-added nutrients in the grease can be collected. Therefore, the use value of grease can be greatly improved.

### CROSS REFERENCE TO RELATED APPLICATIONS

The present application claims the priority of Chinese patent application CN201710872768.1, entitled “Method and Equipment for Grease Purification” and filed on Sep. 25, 2017, the entirety of which is incorporated herein by reference.

### FIELD OF THE INVENTION

The present disclosure relates to the technical field of grease purification, and particularly to a grease purification method through hydrolysis, flash evaporation, and separation steps and equipment used in the method. Fatty acid with a high purity can be produced, and glycerin, as well as sterol, vitamin, pigment, unsaturated fatty acid and other nutrients can be produced as co-products by this method.

### BACKGROUND OF THE INVENTION

Bio-grease (including animal grease and vegetable grease) mainly contains glyceride, and also contains glycolipid, phospholipid, sterol, vitamin, and pigment (which mainly exists in vegetable grease). Waste grease not only contains the aforementioned organic substances, but also contains a large amount of inorganic salts. In order to obtain biofuel (bio-jet fuel and biodiesel) with a high quality, there is a high requirement for the quality of grease as a raw material. That is, bio-grease and waste grease should be pre-treated to remove metal, phospholipid, vitamin, unsaturated fatty acid and other substances which would do harm to hydrogenation heteroatom removal reaction. Once these substances are removed, energy consumption and hydrogen consumption during refining process can be greatly reduced. The traditional glyceride purification method includes a solvent extraction and separation technology and a high-temperature washing technology. As to the solvent extraction and separation technology, since large energy consumption is needed during separation of extractant and grease, and solvent volatilization will lead to environmental pollution, the use of this technology is limited. If the high-temperature washing technology is used, salt and other substances which are soluble in water can be easily removed, but water consumption is rather high due to low water solubility of vitamin, sterol, and pigment. As a result, not only grease will lose, but also a large amount of waste water will be generated during this process. At present, there are also supercritical extraction, molecular distillation and other purification technologies. These technologies have high efficiencies, but have high costs. There are technical and economic restrictions for large-scale use of these technologies. Besides, oxygen in the glyceride will consume hydrogen to generate water so as to be removed during hydrogenation process, and hydrogen consumption is relatively high. If glycerin skeleton is removed to form fatty acid before hydrogenation process, the hydrogen consumption will be largely reduced. Therefore, it is necessary to develop a green technology for grease purification and a method for reducing oxygen content in glyceride.

### SUMMARY OF THE INVENTION

In order to solve the technical problem in the prior art, the present disclosure provides a grease purification method through hydrolysis, flash evaporation, and cooling separation steps. According to this method, heat needed in the system is provided by solar energy, which is green and environmental friendly. By this method, fatty acid with a high purity can be obtained; glycerin can be obtained as a co-product; and high value-added nutrients in the grease can be collected. Therefore, the use value of grease can be greatly improved.

According to a first aspect, the present disclosure provides a method for grease purification. The method comprises steps of:

S1, feeding crude grease into a grease hydrolysis column to be hydrolysed so as to obtain aqueous phase, organic phase, and middle layer substances between the aqueous phase and the organic phase;

S2, feeding the organic phase and the middle layer substances in the grease hydrolysis column into a flash stripping column to be flashed so as to obtain vaporized products and non-vaporized products; and

S3, feeding the vaporized products in the flash stripping column into a separation column to be separated so as to obtain fatty acid.

According to the present disclosure, in step S1, glyceride in the crude grease is hydrolysed to fatty acid and glycerin in the grease hydrolysis column, and glycolipid, phospholipid and other substances are hydrolysed to fatty acid and small molecular substances. The aqueous phase comprises glycerin, water, and some water-soluble salts. The aqueous phase is in a lower layer of the grease hydrolysis column. The organic phase comprises fatty acid, aldehyde and ketone, and is in an upper layer of the grease hydrolysis column. Sterol, pigment, vitamin, unsaturated fatty acid and other macromolecular nutrients contained in the crude grease have high viscosity and lower density than water, and are in a middle layer between the aqueous phase and the organic phase. That is, sterol, pigment, vitamin, unsaturated fatty acid and other macromolecular nutrients contained in the crude grease are middle layer substances between the aqueous phase and the organic phase.

According to one preferred embodiment of the present disclosure, the aqueous phase in the grease hydrolysis column is discharged therefrom and is fed into a first heat exchanger to exchange heat with crude grease. The aqueous phase is heated by a second heat exchanger and is returned to the grease hydrolysis column for hydrolysis reaction. The crude grease exchanges heat with the aqueous phase discharged from the grease hydrolysis column. That is, the aqueous phase serves as a heat medium to heat the crude grease, so as to improve a temperature of the crude grease fed into the grease hydrolysis column as a raw material and reduce energy consumption of the grease hydrolysis column. The aqueous phase is then heated by the second heat exchanger to improve a temperature thereof. In this manner, the temperature of the aqueous phase fed into the grease hydrolysis column can be improved, and heat consumption of the grease hydrolysis column can be reduced. According to one preferred embodiment of the present disclosure, the second heat exchanger uses hot stream with a temperature in a range from 150° C. to 200° C. obtained by a second solar energy collecting device as a heat source.

The aqueous phase discharged from the grease hydrolysis column, after heat exchange, is then fed into the grease hydrolysis column again for hydrolysis reaction. Glycerin is concentrated during hydrolysis process. According to one preferred embodiment of the present disclosure, when a mass concentration of glycerin in the aqueous phase reaches 50% to 75%, preferably reaches 60% to 70%, part of the aqueous phase is discharged and water is supplemented to ensure that an upper surface of the aqueous phase in the grease hydrolysis column (or a lower surface of the organic phase, or an interface where the middle layer substances are located) is in a middle part of the grease hydrolysis column. The aqueous phase discharged from the grease hydrolysis column is collected, and glycerin with a high mass concentration is obtained.

In some cases, salt content in the crude grease is relatively high, and the aqueous phase needs to be discharged periodically in order to prevent corrosion on the system by salt accumulation in the aqueous phase.

According to one preferred embodiment of the present disclosure, according to difference between mass concentrations of unsaturated fatty acid in the crude grease, the crude grease is classified into high unsaturated fatty acid contained crude grease with a mass concentration of unsaturated fatty acid in a range from 15% to 50% and low unsaturated fatty acid contained crude grease with a mass concentration of unsaturated fatty acid lower than 15%. The high unsaturated fatty acid contained crude grease is hydrolysed by a medium pressure hydrolysis method, and the low unsaturated fatty acid contained crude grease is hydrolysed by a high pressure hydrolysis method. Preferably, a pressure of the high pressure hydrolysis method is in a range from 4.5 Mpa to 5.5 Mpa, and/or a temperature thereof is in a range from 245° C. to 300° C., more preferably in a range from 250° C. to 275° C. A pressure of the medium pressure hydrolysis method is in a range from 2.5 Mpa to 4.0 Mpa, and/or a temperature thereof is in a range from 210° C. to 240° C.

According to one preferred embodiment of the present disclosure, a mass ratio of the crude grease to the aqueous phase fed into the grease hydrolysis column is 1:2 to 1:4, preferably 1:3, and/or a mass space velocity of raw material fed into the grease hydrolysis column is 0.1 h⁻¹ to 1 h⁻¹, preferably 0.15 h⁻¹ to 1 h⁻¹. The “mass ratio of the crude grease to the aqueous phase” refers to a mass ratio of the crude grease fed into the grease hydrolysis column to the aqueous phase fed into the grease hydrolysis column. According to the present disclosure, “the aqueous phase” refers to a mixture of water, glycerin and a small amount of water-soluble salt. The “mass space velocity of raw material fed into the grease hydrolysis column” refers to a total mass space velocity of the crude grease fed into the grease hydrolysis column and the aqueous phase returned from the second heat exchanger to the grease hydrolysis column.

According to one preferred embodiment of the present disclosure, operating conditions of the grease hydrolysis column are: a hydrolysis temperature being in a range from 220° C. to 240° C., and/or a pressure being in a range from 3.0 MPa to 4.0 MPa. The mass space velocity of raw material fed into the grease hydrolysis column is 0.15 h⁻¹ to 1 h⁻¹, and the mass ratio of the crude grease to the aqueous phase fed into the grease hydrolysis column is 1:3. In the grease hydrolysis column, a grease hydrolysis ratio is in a range from 95% to 99%. There are many factors affecting hydrolysis process in the grease hydrolysis column, such as temperature, pressure, time and so on. These factors are interrelated to each other and act commonly to affect the hydrolysis efficiency. Hydrolysis temperature is a main factor. If the hydrolysis temperature is too low, the grease cannot be completely hydrolysed to fatty acid and glycerin. If the hydrolysis temperature is too high, the hydrolysis speed will be accelerated, but it will result in further decomposition or coking of crude grease and fatty acid. The temperature and pressure both influence the physical state, namely vapor-liquid equilibrium of the aqueous phase and the organic phase during the hydrolysis process.

According to one preferred embodiment of the present disclosure, operating conditions of the flash stripping column are: a temperature being in a range from 210° C. to 240° C., and/or a pressure being in a range from 0.3 KPa to 0.5 KPa. In the flash stripping column, since the pressure drops rapidly, the fatty acid is immediately flashed into vapor, and non-vaporized products remain in a bottom of the flash stripping column. The non-vaporized products in the flash stripping column contain sterol, vitamin, unsaturated fatty acid (such as docosahexaenoic acid (DHA) and eicosapentaenoic acid (EPA)), pigments (such as chlorophyll and lutein) and so on. These high value-added nutrients are collected by the flash stripping column, and use value of grease can be improved.

According to one preferred embodiment of the present disclosure, the separation column is a cooling column. Preferably, an operating temperature of the cooling column is in a range from 100° C. to 115° C., and/or the cooling column uses water as a cooling medium. The vaporized products of the flash stripping column are fed into the cooling column and are cooled by a cooling water coil. Light fraction of acid, aldehyde and ketone are discharged from a top of the cooling column, and fatty acid with a high purity can be obtained at a bottom of the cooling column.

According to one preferred embodiment of the present disclosure, cooling water of the cooling column serves as supplementary water of the aqueous phase. The cooling water from the cooling column is mixed with the aqueous phase discharged from the grease hydrolysis column to form a mixture, which is then heated by the second heat exchanger and returned to the grease hydrolysis column for hydrolysis reaction. On the one hand, since the cooling water of the cooling column serves as supplementary water of the aqueous phase, the total use amount of water during the whole process can be reduced. On the other hand, since condensed water in the cooling column absorbs heat in the cooling column, and the water temperature is improved, energy consumption in the following steps can be reduced.

According to one preferred embodiment of the present disclosure, heat of the grease hydrolysis column and heat of the flash stripping column are provided by vapor from a third heat exchanger. Preferably, the third heat exchanger uses hot stream with a temperature in a range from 250° C. to 350° C. obtained by a first solar energy collecting device as a heat source.

According to one preferred embodiment of the present disclosure, vapor from the third heat exchanger is divided into a first vapor and a second vapor. The first vapor flows through the flash stripping column, and is then mixed with the second vapor to form a mixture, which then flows through the grease hydrolysis column and is then returned to the third heat exchanger. In this manner, the heat of the vapor can be fully utilized. The first vapor provides heat to the flash stripping column and the grease hydrolysis column.

According to one preferred embodiment of the present disclosure, before the reaction of producing fatty acid with crude grease, a N₂ replacement system is used to eliminate the influence of oxygen on the hydrolysis reaction.

According to a second aspect, the present disclosure provides equipment used in the method for producing fatty acid by crude grease. The equipment comprises a first solar energy collecting device, a second solar energy collecting device, an aqueous phase circulating system, and a grease purification and fatty acid production system. The grease purification and fatty acid production system comprises a grease hydrolysis column, a flash stripping column, and a cooling column which are connected in sequence. The first solar energy collecting device is connected to a third heat exchanger, which is connected to the grease hydrolysis column and the flash stripping column through vapor pipelines. The aqueous phase circulating system comprises a first heat exchanger, an aqueous phase storage tank, a second heat exchanger, and a grease hydrolysis column in sequence along a flow direction of an aqueous phase, wherein the first heat exchanger is provided on a crude grease feeding pipeline for heat exchange between the aqueous phase and the crude grease. A condensed water outlet of the cooling column is connected to the aqueous phase storage tank through a pipeline.

According to one preferred embodiment of the present disclosure, the aqueous phase storage tank is provided with an outlet, so that part of the aqueous phase is discharged when the mass concentration of glycerin in the aqueous phase reaches a certain value.

According to one preferred embodiment of the present disclosure, a vapor pipeline outlet of the grease hydrolysis column is connected to a vapor pipeline inlet of the flash stripping column.

According to one preferred embodiment of the present disclosure, the first solar energy collecting device or the second solar energy collecting device comprises heat collectors. Each heat collector is a trough heat collector, which comprises a trough reflector, a vacuum glass heat collecting pipe, and a bracket. The heat collectors are in series connection with one another to form heat collector groups, and the heat collector groups are in parallel connection with one another. A number of the heat collector groups in parallel connection with one another can be adjusted according to the amount of the grease, and a number of the heat collectors in series connection with one another can be adjusted according to heat to be collected and radiation strength of sun. For example, if the amount of grease to be treated is large, the number of the heat collector groups in parallel connection with one another should be increased. If the radiation strength of sun is low and/or the energy needed by the system is high, the number of the heat collectors in series connection with one another should be increased. If the radiation strength of sun is high and/or the energy needed by the system is low, the number of the heat collectors in series connection with one another and/or the number of the heat collector groups in parallel connection with one another should be decreased.

The following beneficial effects can be brought about by the present disclosure.

(1) According to the present disclosure, fatty acid with a high purity of 90% to 98%, and glycerin with a high concentration of 50% to 72% can be obtained through hydrolysis, flash evaporation, and separation steps, and high value-added nutrients, such as sterol, vitamin, DHA, EPA, chlorophyll and/or lutein can be collected. According to the present disclosure, through adjusting the hydrolysis and flash evaporation processes, different kinds of grease can be purified to produce fatty acid, as well as glycerin and nutrients as co-products.

(2) According to the present disclosure, a regenerative energy, i.e., solar energy is used as the heat source during grease purification process, while no fossil energy or no solvent is used. Since the regenerative energy is used, fossil energy consumption can be avoided. Since no solvent is used, environmental pollution can be reduced. The method is green and environmental friendly.

(3) The aqueous phase discharged from the grease hydrolysis column exchanges heat with the crude grease, and the temperature of the crude grease can be improved with the aqueous phase as heat exchange medium. Then, the aqueous phase is heated by hot stream obtained from the solar energy collecting device, and is returned to the grease hydrolysis column. In this manner, the energy of the aqueous phase can be fully utilized. In addition, according to the present disclosure, the cooling water from the cooling column is used as the supplementary water of the aqueous phase. The cooling water in the cooling column absorbs heat fully, and the heat released by substances in the cooling column during cooling process can be fully utilized. Moreover, according to the present disclosure, vapor from the third heat exchanger is divided into a first vapor and a second vapor. The first vapor flows through the flash stripping column, and is then mixed with the second vapor to form a mixture, which then flows through the grease hydrolysis column and is then returned to the third heat exchanger. According to the present disclosure, heat energy can be utilized fully in a step by step manner. The energy consumption can be reduced, and the method is energy saving and environmental friendly.

(4) According to the present disclosure, two solar energy collecting devices are used, so that the influence of transient changes of solar energy collecting process on the heat collectors can be reduced, and the two solar energy collecting devices can be used in a complementary manner to ensure heat demand of the system.

(5) According to the present disclosure, the aqueous phase obtained from the grease hydrolysis column is used as a heat exchange medium, and the aqueous phase, after circulation, is returned to the grease hydrolysis column for hydrolysis reaction. Glycerin is concentrated to obtain glycerin with a high concentration, and the amount of water used therein can be largely reduced.

(6) According to the present disclosure, fatty acid can be obtained, and high value-added nutrients in the grease can be effectively separated from other substances. Therefore, the use value of grease can be greatly increased.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 is a flow chart according to one preferred embodiment of the present disclosure.

### DETAILED DESCRIPTION OF THE EMBODIMENTS

The present disclosure will be illustrated in detail hereinafter in combination with the embodiments, but the present disclosure is not limited to the embodiments disclosed herein.

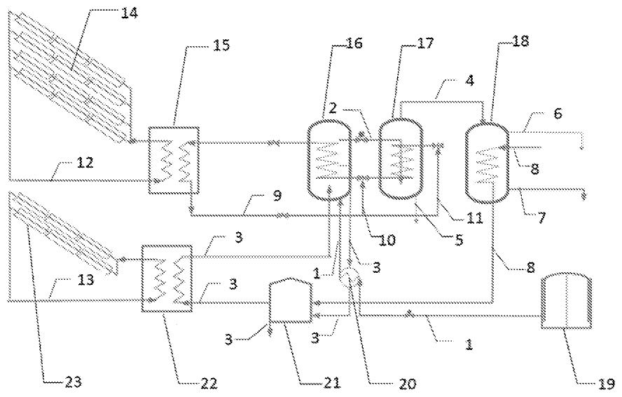

FIG. 1 is a flow chart according to one preferred embodiment of the present disclosure. Crude grease exchanges heat with aqueous phase in a first heat exchanger, and is fed into a grease hydrolysis column to be hydrolysed. In the grease hydrolysis column, high unsaturated fatty acid contained crude grease with a mass concentration of unsaturated fatty acid in a range from 15% to 50% is hydrolysed by a medium pressure hydrolysis method, and low unsaturated fatty acid contained crude grease with a mass concentration of unsaturated fatty acid lower than 15% is hydrolysed by a high pressure hydrolysis method. A pressure of the high pressure hydrolysis method is in a range from 4.5 Mpa to 5.5 Mpa, and/or a temperature thereof is in a range from 245° C. to 300° C. A pressure of the medium pressure hydrolysis method is in a range from 2.5 Mpa to 4.0 Mpa, and/or a temperature thereof is in a range from 210° C. to 240° C. The crude grease is hydrolysed in the grease hydrolysis column to obtain organic phase containing fatty acid in an upper layer, aqueous phase containing glycerin in a lower layer, and macromolecular insolubles in a middle layer between the aqueous phase and the organic phase. The organic phase and the middle layer substances (non-aqueous phase) obtained in the grease hydrolysis column are fed into a flash stripping column to be flashed so as to obtain vaporized products and non-vaporized products. Operating conditions of the flash stripping column are: a temperature being in a range from 210° C. to 240° C., and/or a pressure being in a range from 0.3 KPa to 0.5 KPa. The vaporized products from the flash stripping column are fed into a cooling column, and an operating temperature of the cooling column is in a range from 100° C. to 115° C. Light fraction of acid, aldehyde and ketone are discharged from a top of the cooling column, and fatty acid with a high purity can be obtained at a bottom of the cooling column. The cooling column uses water as a cooling medium. During this process, heat of the grease hydrolysis column and heat of the flash stripping column are provided by vapor from a third heat exchanger. The third heat exchanger uses hot stream with a temperature in a range from 250° C. to 350° C. obtained by a first solar energy collecting device as a heat source. Vapor with a high temperature from the third heat exchanger is divided into a first vapor and a second vapor. The first vapor flows into the flash stripping column to provide heat to the flash stripping column, and then flows out of the flash stripping column and is mixed with the second vapor to form a mixture, which then flows into the grease hydrolysis column to provide heat to the grease hydrolysis column, and is then returned to the third heat exchanger.

The aqueous phase in the lower layer of the grease hydrolysis column is discharged, and is fed into a first heat exchanger to exchange heat with the crude grease. The crude grease is heated, and is fed into the grease hydrolysis column. The aqueous phase is used in a circulating manner. During the aqueous phase circulation process, when a mass concentration of glycerin in the aqueous phase reaches 60% to 70%, part of the aqueous phase is discharged from an aqueous phase storage tank. Residual part of the aqueous phase is mixed with condensed water from the cooling column to form a mixture, which is fed into a second heat exchanger to be heated, and is then returned to the grease hydrolysis column to be hydrolysed. The second heat exchanger uses hot stream with a temperature in a range from 150° C. to 200° C. obtained by a second solar energy collecting device as a heat source.

### Embodiment 1

A method for purifying waste grease (the waste grease has an unsaturated fatty acid content in a range from 7% to 15%, and is a low unsaturated fatty acid contained grease) and producing fatty acid, as well as glycerin and nutrients as co-products using solar energy. The method comprises following steps. Before waste grease purification, a N₂ replacement system is used to remove the influence of oxygen on hydrolysis reaction. The waste grease exchanges heat with aqueous phase discharged from a grease hydrolysis column, and is fed into the grease hydrolysis column. Operating conditions of the grease hydrolysis column are: a pressure being in a range from 4.5 MPa to 5.0 MPa, and a temperature being 280° C. A mass ratio of the crude grease to the aqueous phase fed into the grease hydrolysis column is 1:3, and a total mass space velocity of the crude grease and the aqueous phase fed into the grease hydrolysis column is 0.5 W⁻¹. In the grease hydrolysis column, the crude grease is hydrolysed to fatty acid and glycerin. Glycerin is mainly contained in the aqueous phase, and is in a lower layer of the grease hydrolysis column. Organic phase contains fatty acid and a small amount of aldehyde and ketone, and is in an upper layer of the grease hydrolysis column. Pigments, sterol, and vitamin are in a middle layer between the aqueous phase and the organic phase. The organic phase and the middle layer substances (non-aqueous phase) in the grease hydrolysis column are fed into a flash stripping column. An operating temperature of the flash stripping column is 230° C., and a pressure thereof is 0.35 Kpa. Fatty acid is immediately vaporized in the flash stripping column and then enters into a cooling column. Non-vaporized products in the flash stripping column include sterol, vitamin, DHA, EPA, chlorophyll, lutein and other substances. Vaporized products of the flash stripping column are cooled in the cooling column. An operating temperature of the cooling column is 100° C. Light fraction of acid, aldehyde and ketone are separated from fatty acid, and fatty acid with a purity of 98% is obtained.

The aqueous phase in the grease hydrolysis column is discharged therefrom, exchanges heat with crude grease, and enters into an aqueous phase storage tank. The aqueous phase is heated by a second heat exchanger, and is then returned to the grease hydrolysis column. The aqueous phase is used in a circulating manner. During the aqueous phase circulation process, when a mass concentration of glycerin in the aqueous phase reaches 70%, part of the aqueous phase is discharged and water is supplemented to ensure that an upper surface of the aqueous phase in the grease hydrolysis column is in a middle part of the grease hydrolysis column. The discharged aqueous phase is collected to obtain glycerin with a concentration of 70%.

### Embodiment 2

A method for purifying microalgae grease (the microalgae grease has an unsaturated fatty acid content in a range from 20% to 30%, and is a high unsaturated fatty acid contained grease) and producing fatty acid, as well as glycerin and nutrients as co-products using solar energy. The method comprises following steps. Before microalgae grease purification, a N₂ replacement system is used to remove the influence of oxygen on hydrolysis reaction. The microalgae grease exchanges heat with aqueous phase discharged from a grease hydrolysis column, and is fed into the grease hydrolysis column. Operating conditions of the grease hydrolysis column are: a pressure being in a range from 2.5 MPa to 3.0 MPa, and a temperature being 210° C. A mass ratio of the crude grease to the aqueous phase fed into the grease hydrolysis column is 1:3, and a total mass space velocity of the crude grease and the aqueous phase fed into the grease hydrolysis column is 0.75 h⁻¹. In the grease hydrolysis column, the crude grease is hydrolysed to fatty acid and glycerin. Glycerin is mainly contained in the aqueous phase, and is in a lower layer of the grease hydrolysis column. Organic phase contains fatty acid and a small amount of aldehyde and ketone, and is in an upper layer of the grease hydrolysis column. Pigments, sterol, and vitamin are in a middle layer between the aqueous phase and the organic phase. The organic phase and the middle layer substances (non-aqueous phase) in the grease hydrolysis column are fed into a flash stripping column. An operating temperature of the flash stripping column is 210° C., and a pressure thereof is 0.3 Kpa. Fatty acid, aldehyde and ketone are immediately vaporized in the flash stripping column and enter into a cooling column. Non-vaporized products of the flash stripping column include sterol, vitamin, DHA, EPA, chlorophyll, lutein and other substances. Vaporized products of the flash stripping column are cooled in the cooling column. An operating temperature of the cooling column is 100° C. Light fraction of C₂-C₅ acid, aldehyde and ketone are separated from fatty acid, and fatty acid with a purity of 96% is obtained.

The aqueous phase in the grease hydrolysis column is discharged therefrom, exchanges heat with crude grease, and enters into an aqueous phase storage tank. The aqueous phase is heated by a second heat exchanger, and is then returned to the grease hydrolysis column. The aqueous phase is used in a circulating manner. During the aqueous phase circulation process, when a mass concentration of glycerin in the aqueous phase reaches 60% to 70%, part of the aqueous phase is discharged and water is supplemented to ensure that an upper surface of the aqueous phase in the grease hydrolysis column is in a middle part of the grease hydrolysis column. The discharged aqueous phase is collected to obtain glycerin with a concentration of 60% to 70%.

It should be noted that, the above embodiments are only used for explaining the present disclosure, rather than limiting the present disclosure. The present disclosure is described with reference to the exemplary embodiments, but it should be understood that words used therein are explanatory words, rather than definitive words. The present disclosure can be modified within the scope of the claims according to regulations. Also, amendments can be made to the present disclosure without departing from the scope and spirit thereof. Although the present disclosure relates to specific methods, materials, and embodiments, it is not intended that the present disclosure is limited to the specific embodiments disclosed herein. The present disclosure can be extended to all other methods and applications having same functions.

### LIST OF REFERENCE SIGNS

1—crude grease;

2—organic phase and middle layer substances;

3—aqueous phase;

4—vaporized products;

5—non-vaporized products (sterol, vitamin, pigment and so on);

6—light fraction of acid, aldehyde and ketone;

7—fatty acid;

8—cooling water;

9—vapor;

10—second vapor;

11—first vapor;

12—hot stream with a temperature in a range from 250° C. to 350° C. obtained by a first solar energy collecting device;

13—hot stream with a temperature in a range from 150° C. to 200° C. obtained by a second solar energy collecting device;

14—first solar energy collecting device;

15—third heat exchanger;

16—grease hydrolysis column;

17—flash stripping column;

18—cooling column;

19—crude grease tank;

20—first heat exchanger;

21—aqueous phase storage tank;

22—second heat exchaner; and

23—second solar energy collecting device.

1. A method for grease purification, comprising steps of:
S1, feeding crude grease into a grease hydrolysis column to be hydrolysed so as to obtain an aqueous phase, an organic phase, and middle layer substances between the aqueous phase and the organic phase;
S2, feeding the organic phase and the middle layer substances in the grease hydrolysis column into a flash stripping column to be flashed to obtain vaporized products and non-vaporized products; and
S3, feeding the vaporized products in the flash stripping column into a separation column to be separated to obtain fatty acid.

2. The method according to claim 1, wherein the aqueous phase comprises glycerin and water; wherein the aqueous phase in the grease hydrolysis column is discharged therefrom and is fed into a first heat exchanger to exchange heat with crude grease, and the crude grease is fed into the grease hydrolysis column to be hydrolysed; and wherein the aqueous phase is heated by a second heat exchanger and is returned to the grease hydrolysis column for hydrolysis reaction.

3. The method according to claim 2, wherein the second heat exchanger uses hot stream with a temperature in a range from 150° C. to 200° C. obtained by a second solar energy collecting device as a heat source.

4. The method according to claim 1, wherein when a mass concentration of glycerin in the aqueous phase reaches 50% to 75%, part of the aqueous phase is discharged and water is supplemented to ensure that an upper surface of the aqueous phase in the grease hydrolysis column is in a middle part of the grease hydrolysis column.

5. The method according to claim 4, wherein when a mass concentration of glycerin in the aqueous phase reaches 60% to 70%, part of the aqueous phase is discharged and water is supplemented to ensure that an upper surface of the aqueous phase in the grease hydrolysis column is in a middle part of the grease hydrolysis column.

6. The method according to claim 1, wherein the crude grease is classified into high unsaturated fatty acid contained crude grease with a mass concentration of unsaturated fatty acid in a range from 15% to 50% and low unsaturated fatty acid contained crude grease with a mass concentration of unsaturated fatty acid lower than 15%; and wherein the high unsaturated fatty acid contained crude grease is hydrolysed by a medium pressure hydrolysis method, and the low unsaturated fatty acid contained crude grease is hydrolysed by a high pressure hydrolysis method.

7. The method according to claim 6, wherein a pressure of the high pressure hydrolysis method is in a range from 4.5 Mpa to 5.5 Mpa, and/or a temperature thereof is in a range from 245° C. to 300° C.; and
wherein a pressure of the medium pressure hydrolysis method is in a range from 2.5 Mpa to 4.0 Mpa, and/or a temperature thereof is in a range from 210° C. to 240° C.

8. The method according to claim 2, wherein a mass ratio of the crude grease to the aqueous phase fed into the grease hydrolysis column is 1:2 to 1:4, and a total mass space velocity of the crude grease and the aqueous phase fed into the grease hydrolysis column is 0.1⁻¹ to 1 h⁻¹.

9. The method according to claim 8, wherein a total mass space velocity of the crude grease and the aqueous phase fed into the grease hydrolysis column is 0.15 ⁻¹ to 1 h⁻¹.

10. The method according to claim 1, wherein operating conditions of the flash stripping column are: a temperature being in a range from 210° C. to 240° C., and/or a pressure being in a range from 0.3 KPa to 0.5 KPa.

11. The method according to claim 1, wherein the separation column is a cooling column; and wherein an operating temperature of the cooling column is in a range from 100° C. to 115° C., and/or the cooling column uses water as a cooling medium.

12. The method according to claim 11, wherein cooling water from the cooling column is mixed with the aqueous phase discharged from the grease hydrolysis column to form a mixture, which is then heated by the second heat exchanger and returned to the grease hydrolysis column for hydrolysis reaction.

13. The method according to claim 1, wherein heat of the grease hydrolysis column and heat of the flash stripping column are provided by vapor from a third heat exchanger.

14. The method according to claim 13, wherein the third heat exchanger uses hot stream with a temperature in a range from 250° C. to 350° C. obtained by a first solar energy collecting device as a heat source.

15. The method according to claim 13, wherein vapor from the third heat exchanger is divided into a first vapor and a second vapor, wherein:
the first vapor flows through the flash stripping column, and is then mixed with the second vapor to form a mixture, which then flows through the grease hydrolysis column and is then returned to the third heat exchanger.

16. An apparatus for use in the method according to claim 1, comprising a first solar energy collecting device, a second solar energy collecting device, an aqueous phase circulating system, and a grease purification and fatty acid production system,
wherein the grease purification and fatty acid production system comprises a grease hydrolysis column, a flash stripping column, and a cooling column which are connected in sequence;
wherein the first solar energy collecting device is connected to a third heat exchanger, which is connected to the grease hydrolysis column and the flash stripping column through vapor pipelines; and
wherein the aqueous phase circulating system comprises a first heat exchanger, an aqueous phase storage tank, a second heat exchanger, and a grease hydrolysis column in sequence along a flow direction of an aqueous phase, wherein the first heat exchanger is provided on a crude grease feeding pipeline for heat exchange between the aqueous phase and the crude grease.

17. The apparatus according to claim 16, wherein a condensed water outlet of the cooling column is connected to the aqueous phase storage tank through a pipeline, and/or a vapor pipeline outlet of the grease hydrolysis column is connected to a vapor pipeline inlet of the flash stripping column; and
wherein the first solar energy collecting device or the second solar energy collecting device comprises heat collectors.

18. The apparatus according to claim 17, wherein each heat collector is a trough heat collector, which comprises a trough reflector, a vacuum glass heat collecting pipe, and a bracket; and
wherein the heat collectors are in series connection with one another to form heat collector groups, and the heat collector groups are in parallel connection with one another.
